(19) United States
(12) Patent Application Publication
(10) Pub. No.: US 2017/0351029 A1
(43) Pub. Date: Dec. 7, 2017

(54) OPTICAL FIBER ASSEMBLY WITH BEAM SHAPING COMPONENT

(71) Applicant: Coractive High-Tech Inc., Quebec (CA)

(72) Inventors: Bertrand Morasse, Quebec (CA); Nezih Belhaj, Quebec (CA)

(21) Appl. No.: 15/521,106

(22) PCT Filed: Oct. 23, 2014
(86) PCT No.: PCT/CA2014/051024

§ 371 Date: Apr. 21, 2017

(51) Int. Cl. G02B 6/26; G02B 6/036; G02B 6/028

(52) U.S. Cl. CPC G02B 6/262; G02B 6/0288; G02B 6/03611

(57) ABSTRACT

An optical fiber assembly is provided including an optical fiber and a beam shaping component affixed to an extremity of the optical fiber. The optical fiber supports a guided mode having a spatial profile defining a first shape. The beam shaping component defines a light path and has a transversal refractive index profile including an outer refractive index value greater than an inner refractive index value. The beam shaping component transforms the spatial profile of a light beam propagating along the light path between the first shape and a second shape different from the first shape. The optical assembly may for example transform a Gaussian light beam into a flat-top or donut shape.

### FIELD OF THE INVENTION

The present invention related to the field of optical fibers, and more particularly concerns an optical fiber assembly having a beam shaping component projecting from an extremity of an optical fiber.

### BACKGROUND

Optical fibers are used to guide light for a multitude of applications. In standard single-mode optical fibers, the guided light propagates in one available mode in which light is spatially distributed so that its intensity defines a Gaussian-like profile transversally to the longitudinal axis of the fiber, that is, a transversal light distribution that strongly resembles a Gaussian shape. The fundamental mode of multimode optical fibers also defines a Gaussian-like shape.

For some applications, it may be desired for the light outputted from the optical fiber to have a different spatial profile. For example for machining application, it is often preferable for the light beam to have a well-defined profile with sharp transitions, such as a “flat top” profile with a transition at the edge of the beam as abrupt as possible and a constant light intensity between these edges. Flat-top profiles are also useful for coupling light into an integrated optical waveguide. Among other possible shapes, “donut-like” shapes, where the beam profile defines a ring of higher intensity around a dark or low intensity center, are also of interest, for instance in optical microscopy, plastic processing, and laser trapping applications.

Various techniques are known in the art to convert a Gaussian beam guided by a typical optical fiber into a flat-top beam or other shapes differing from the standard Gaussian-like profile.

Several such techniques involve the uses of bulk elements disposed downstream the output of the optical fiber, such as lenses, filters, diffractive elements and the like. Aspherical lenses in various configurations are commonly used for this purpose. Free space solutions however suffer from several drawbacks. They are often bulky, they can be heavily dependent on the alignment of the components, have low fabrication tolerances and typically suffer from low efficiency.

MAYEH et al. (“Laser Beam Shaping and Mode Conversion in Optical Fibers”, Photonic Sensors (2011) Vol. 1 No. 2: 187-198) teach a beam conversion scheme where the end of a single-mode optical fiber is modified by inverse etching in order to form a concave cone tip. The etched cone may be confined to the core of the fiber or extend into the cladding. This approach can provide a somewhat flat-top-shaped output from a Gaussian beam propagating in the single mode fiber.

Other beam shaping methods involving a transformation of the optical fiber carrying the light beam include the provision of a LPG (Long Period Grating) in the fiber (see for example US2009/00907807 (GU et al)) or an abrupt taper (Tian et al. “Laser beam shaping using a single-mode fiber abrupt taper”, Optics Letters vol. 34, No. 3: 229 (Feb. 1, 2009)). Both methods can however suffer from heavy losses, and LPGs additionally have an inherent wavelength dependency which can be detrimental to several applications.

ZHU et al. (“Coherent beam transformations using multimode waveguides”, Optics Express 7506, Vol. 18, No. 7, 29 March 2010) teach the use of a short piece of cylindrical multimode waveguide affixed at the end of an optical fiber to convert a Gaussian beam into a beam of different shape such as top-hat, donut-shaped, taper-shaped, and Bessel-like beams. This technique is based on the principle of multimode interference (MMI) in the added piece of waveguide. This approach can however suffer from strict fabrication tolerances on the length of the multimode waveguide.

There remains a need for an efficient, simple and low cost beam shaping scheme for converting the spatial profile of a light beam from the Gaussian-like shape typically carried by optical fibers into a flat-top or other desired shape.

### SUMMARY

In accordance with one aspect, there is provided an optical fiber assembly including an optical fiber supporting a guided mode having a spatial profile defining a first shape. The optical assembly further includes a beam shaping component having a first end affixed and optically coupled to an extremity of the optical fiber and a second end opposite the first end. The beam shaping component defines a light path between the first and second ends and has a transversal refractive index profile including an outer refractive index value greater than an inner refractive index value. The beam shaping component transforms the spatial profile of a light beam injected at one of the first and second ends and propagating along the light path between the first shape at the first end and a second shape different from the first shape at the second end.

The optical fiber may be single-mode or multimode. In some embodiments, the beam shaping component may be fused to the extremity of the optical fiber.

Advantageously, in some variants the beam shaping component may transform a light beam from the optical fiber from a Gaussian shape into a non-Gaussian shape, such as for example a “flat-top” or “donut” shape.

In some implementations, the beam shaping component may have an inner region characterized by the inner refractive index value and an outer region characterized by the outer refractive index value. For example, in cases where the optical fiber is a silica-based fiber, the outer region of the beam shaping component may be made of a silica glass, and the inner region of silica glass doped with at least one refractive index-lowering dopant. The refractive index-lowering dopant may for example include Bore, Fluor or a combination thereof. In some variants, the inner region may concentrically include a core, a first ring and a second ring.

Other features and advantages will be better understood upon reading of preferred embodiments with reference to the appended drawings.

### BRIEF DESCRIPTION OF THE DRAWINGS

FIG. 1A is a side cross-sectional view of an optical fiber; FIG. 1B is a side cross-sectional view of an optical assembly including an optical fiber and a beam shaping component.

FIG. 2A is an end view of a beam shaping component according to one embodiment; FIG. 2B is a graph of the transverse refractive index profile of the beam shaping component of FIG. 2A.

FIG. 3A shows the simulated propagation and transformation of a light beam in a beam shaping component such as shown in FIG. 2A; FIG. 3B is a graph of the output non-Gaussian shape obtained from different lengths of the simulated beam shaping component design.

FIG. 4A shows different shapes obtained through varying the diameter of the inner region of the beam shaping component; FIG. 4B shows the same shapes normalized for both amplitude and width; FIG. 4C shows the calculated normalized slopes of the side edges of the beam shapes obtained. FIG. 4D shows the normalized beam profile for different index difference of the beam shaping component.

FIG. 5A is an end view of a beam shaping component according to another embodiment; FIG. 5B is a graph of the transverse refractive index profile of the beam shaping component of FIG. 5A

FIG. 6 shows the simulated propagation and transformation of a light beam in a beam shaping component such as shown in FIG. 5A.

FIG. 7 is a graph comparing the output non-Gaussian shape obtained from the respective refractive index profiles of of FIG. 5B and 2B.

FIG. 8A shows an experimental output beam profile obtained from optical assemblies with beam shaping components of two different lengths; FIG. 8B shows the collimated beam profile using the beam shaping component of 1.1 mm length.

FIG. 9A shows the refractive index of a beam shaping component according to another embodiment; FIG. 9B shows the simulated beam profile exiting a beam shaping component such as shown in FIG. 9A.

FIG. 10 is the refractive index of a beam shaping component according to another embodiment.

FIG. 11A shows the simulated propagation of a light beam in a beam shaping component have a longitudinal tapered section; FIG. 11B shows the corresponding output beam spatial profile for three different taper ratio; using FIG. 11C shows the normalized slope of the profiles of FIG. 11B.

### DESCRIPTION OF EMBODIMENTS

In accordance with embodiments of the invention, there are provided optical assemblies having a beam shaping component affixed to the extremity of an optical fiber.

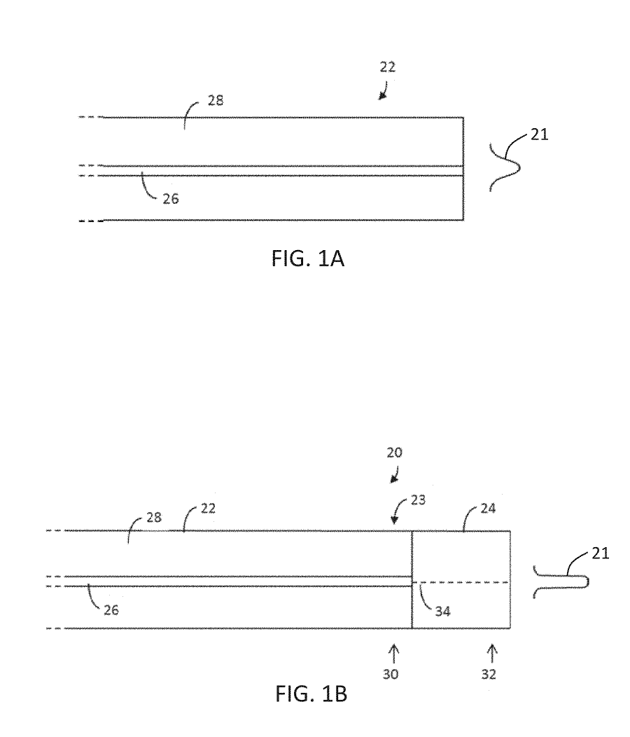

FIG. 1A (PRIOR ART) illustrates an optical fiber 22 and the typical profile 21 of a light beam outputted by such a fiber. Typical optical fibers include a waveguiding core 26 and a cladding 28, and may further include multiple claddings and/or a protective jacket or coating (not shown).

An optical fiber 22 may support one or more guided modes. As will be readily understood by one skilled in the art, the expression “mode” refers to the manner in which light is distributed through space. Modes carried or supported by an optical fiber are typically transverse mode, that is, the electrical field associated with the light beam oscillates along a direction transverse to the propagation direction of the light beam. Hence, each guided mode in an optical fiber has a spatial profile characterized by the light intensity distribution along a plane transverse to the longitudinal axis of the fiber. As will be further understood by one skilled in the art, the expression “guided mode” refers to a mode that is efficiently guided in the fiber structure. The light can thus propagates over long distances, normally in the fiber core, with low loss and preserving its mode distribution. In an optical fiber or other types of waveguides, a guided mode is typically supported by providing an inner refractive index value higher than outer refractive index value, which is analogous to having total internal refraction in geometrical optics.

Optical fibers known in the art may be single-mode, that is, the waveguiding core 26 supports only one guided mode. Typically the spatial profile of light beams outputted by such fibers has a Gaussian-like shape, as illustrated in FIG. 1A. Other types of optical fibers may be multimode, the waveguiding core 26 and/or the cladding 28 therefore supporting multiple guided modes, including a fundamental mode typically having a spatial profile defining a Gaussian-like shape. Throughout the present description, the single guided mode of a single mode fiber and the fundamental mode of a multimode fiber will be referred to as the “”fundamental mode” supported by the fiber. Furthermore, the expressions “Gaussian shape” or “Gaussian profile” as used herein are intended to cover Gaussian-like light distribution patterns resembling a Gaussian curve sufficiently to be perceived as such. One skilled in the art will readily understand that typical optical fibers are considered having a Gaussian fundamental mode even though the light distribution therein does not perfectly reproduce a Gaussian curve.

In accordance with some implementations, it may be desired to transform the spatial profile of a light beam outputted by an optical fiber from the shape corresponding to the guided mode of the fiber, typically a Gaussian shape, to another shape more suited to the application for which the light beam is destined. As explained above, a light beam having a well-defined profile with sharp transitions, such as a flat top profile, can be useful for some applications such as machining application or for coupling light into an integrated optical waveguide. Among other possible shapes, “donut-like” shapes, where the beam profile defines a ring of higher intensity around a dark or low intensity center, are also of interest, for instance in optical microscopy, plastic processing, and laser trapping applications. Such profiles and applications are given by way of example only and should not be considered as limitative to the scope of the present invention.

In other implementations, a light beam having a spatial profile differing from the spatial profile of a guided mode of an optical fiber may need to be transformed into a shape closer to the guided modes supported by the fiber in order to facilitate insertion into the optical fiber. An example of such an implementation is to couple light from a semiconductor diode into an optical fiber. The mode profile of the diode can be adapted using the beam transformation device to obtain a better coupling efficiency into the fiber.

With reference to FIG. 1B, there is schematically illustrated an optical assembly 20 according to one embodiment. The optical assembly 20 includes an optical fiber 22 and a beam shaping component 24. The optical fiber 22 has a waveguiding core 26 and a cladding 28. In some embodiments, the optical fiber may include multiple claddings and/or a protective jacket or coating (not shown). In some embodiments, the optical fiber may be a standard germanium doped fiber, such as used for telecommunication of the like. In other implementations, the optical fiber may be embodied by a specialized fiber such as a polarisation-maintaining fiber, hollow-core fiber, or a microstructured fiber, by way of example. The optical fiber may be made of a suitable material such as silica glass, fluoride, or chalcogenide, and may have any number of dopants such as germanium, aluminum, boron, fluorine. The fiber may additionally or alternatively contain one or more active dopants such as ytterbium, erbium, thulium or any other rare-earth or other element generating or amplifying light.

The optical fiber 22 has a guided mode having a spatial profile 21 defining a first shape. In some embodiments, the optical fiber may be single-mode, in which case the first shape of the spatial profile 21 of the guided mode may be Gaussian. In other implementations, the optical fiber 22 may be multimode. According to one variant, the guided mode of a multimode optical fiber having the first shape may be the fundamental mode, and the first shape can for example be a Gaussian shape. In other variants, the guided mode having the first shape may be a higher order mode or a cladding mode.

Still referring to FIG. 1B, and as mentioned above, the optical assembly 20 includes a beam shaping component 24. The beam shaping component 24 has a first end 30 and a second end 32 opposite the first end 30. The first end 30 is affixed to an extremity 23 of the optical fiber 22 and is optically coupled thereto, so as to receive the guided mode from the optical fiber 22. The beam shaping component 24 may be affixed to the extremity 23 of the optical fiber 22 in a variety of manners. In some implementations, the first end 30 of the beam shaping component 24 is fused with the extremity 23 of the optical fiber 22 according to known techniques of fusion splicing. In other variants, epoxy, glue, sol-gel, or mechanical fixtures can be used to fix the beam shaping component 24 to the optical fiber. As will be readily understood, the method used to affix the beam shaping component to the optical fiber should ensure a suitable optical coupling between these two components, that is, light is allowed to propagate from one to the other with low loss or a level of loss compatible with the requirements of the application to which the optical assembly is destined.

In some implementations, the beam shaping component 24 has a cylindrical shape and is coaxial with the optical fiber 22. In such embodiments the first end 30 and second end 32 are defined by the opposite circular faces of the cylindrical shape. In various embodiments, the diameter of the beam shaping component 24 may be greater, the same or smaller than the diameter of the optical fiber 22. In other embodiments, the beam shaping component may have a shape other than cylindrical without departing from the scope of the invention.

The beam shaping component 24 defines a light path 34 between the first and second ends 30, 32 along which it has a transversal refractive index profile. As well known in the art, the expression “refractive index” refers to an intrinsic property of a material that determines how light propagates therethrough. The expression “transverse profile” is understood to refer to the variation of the refractive index in a plane transverse to the light propagation direction, that is, transvers to the light path 34 in the present example.

Optical fibers typically have a transversal refractive index profile favoring guidance of light along the waveguiding core, which involves the core having a refractive index greater than the surrounding cladding so that the travelling light is reflected at the interface between the two. In one aspect of the optical assembly 20 described herein, the refractive index profile of the beam shaping component 24 includes an outer refractive index value greater than an inner refractive index value. The light travelling along the light path 34 is not guided within the region defined by the lower refractive index value; the beam therefore gradually diverges due to diffraction, which leads to an increasingly larger beam diameter as the beam propagates. As will be explained further below, such a refractive index profile allows the beam shaping component to transform the spatial profile 21 of a light beam injected at one of the first and second ends and propagating along the light path between the first shape at the first end and a second shape different from the first shape at the second end.

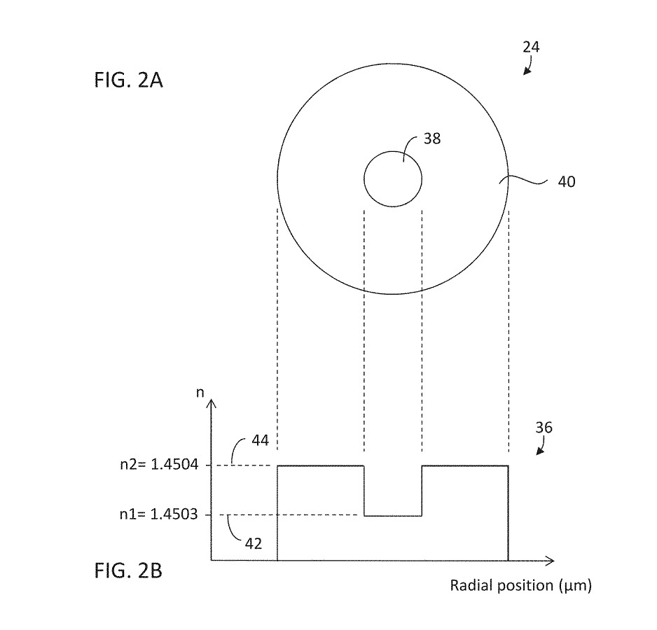

Referring to FIGS. 2A and 2B, there is shown a cross-sectional view of a beam shaping component 24 according to one embodiment, and the corresponding transverse refractive index profile 36. In this embodiment, the beam shaping component 24 includes an inner region 38 and an outer region 40. The transverse refractive index profile 36 of the beam shaping component 24 is characterized by a constant inner refractive index value 42 in the inner region 38 and a constant outer refractive index value 44 in the outer region. As explained above, the outer refractive index value 44 is greater than the inner refractive index value 42. In some implementations, for example in cases where the optical fiber is a silica-based fiber, the outer region 40 of the beam shaping component 24 is made of silica glass. The glass material of the outer region 40 may for example be pure silica or may be doped with one or more dopants such as germanium or aluminum or active dopants such as ytterbium, erbium, thulium or any other rare-earth. Doping can affect the refractive index value of a glass material, as well known in the art. The inner region 38 of the beam shaping component 24 is preferably made of the same silica glass as the outer region 40, additionally doped with at least one refractive index-lowering dopant. The refractive index-lowering dopants may for example be Bore, Fluor or both. The higher the doping level, the lower will be the resulting refractive index, which will in turn affect the beam transformation differently. It will however be understood that in some embodiments, a difference between the inner and outer refractive index values equal to or greater than 1×10⁻⁵ may be sufficient to obtain the desired shape of the spatial profile of the light beam propagating in the beam shaping component. For example, in the illustrated example of FIG. 2B, the outer refractive index value within the outer region 40 is that of pure silica n2=1.4504 around a wavelength of 1 μm, whereas the inner refractive value obtained through doping with a refractive index-lowering dopant is n1=1.4503.

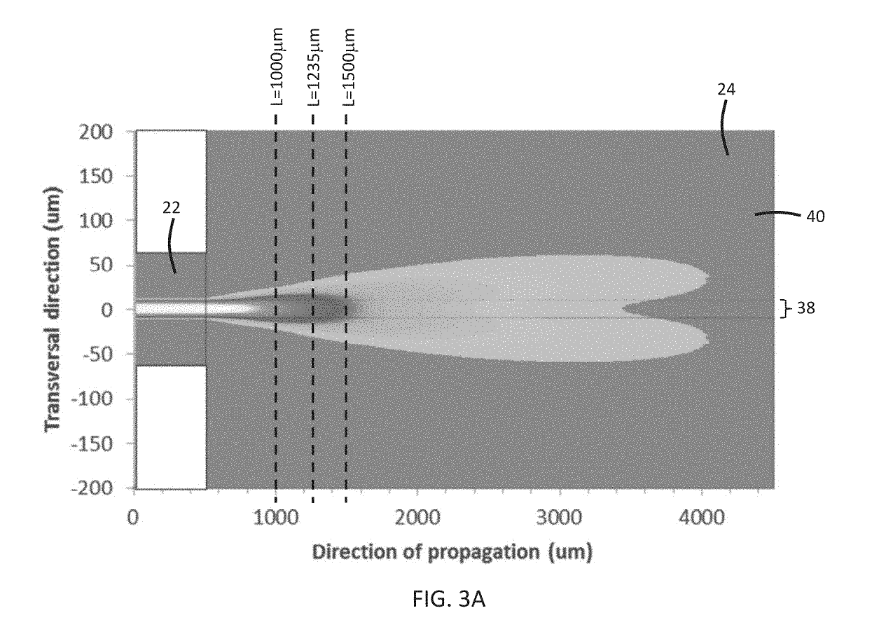

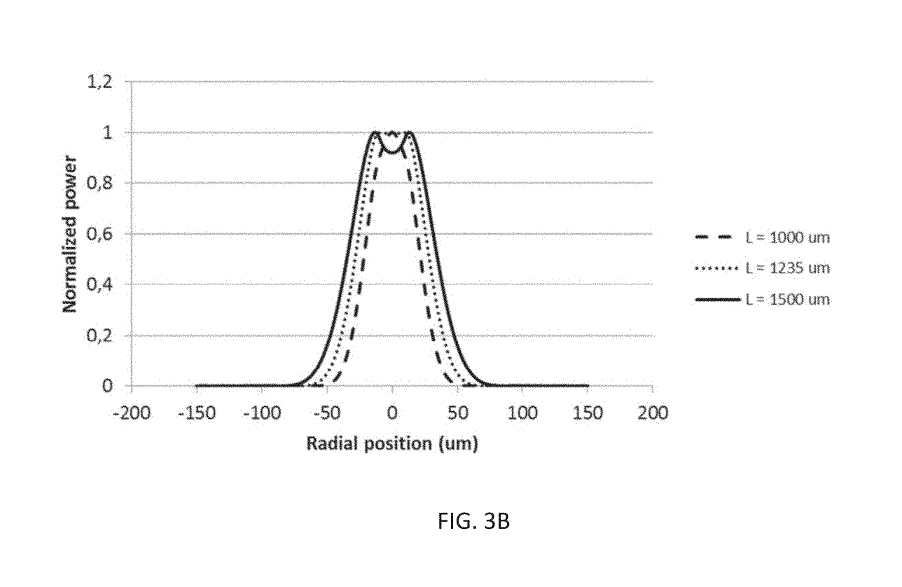

Advantageously, it has been found that a beam shaping component according to some embodiments described herein can transform a guided mode having a Gaussian shape at the first end into a non-Gaussian shape, for example a shape close to a flat top or a donut, at the second end. The length between the first and second ends of the beam shaping component may be selected to provide the desired flat-top shape or donut shape. To illustrate this point, FIG. 3A shows the results of beam propagation simulations for a Gaussian beam through a beam shaping component having a refractive index profile as shown in FIG. 2B. In this simulation example, the Gaussian beam is received from an optical fiber 22 having a core diameter of 20 μm and a numerical aperture (NA) of 0.10 operated at a light wavelength of 1064 nm. The numerical aperture is a dimension-less parameter representative of the acceptance cone within which light can enter or exit, and depends on the refractive indices of the inner and outer regions. The beam shaping component has an inner region 38 having a diameter of 23 μm and has a negative NA of 0.02, “negative” referring to the fact that the refractive index of the inner region 38 is lower than the refractive index of the outer region 40. The resulting graph shows an evolution of the spatial profile of the beam from left to right along the length of the beam shaping component 24. Selecting a given length for the beam shaping component 24 can therefore provide the corresponding shape for the output spatial profile of the travelling light. FIG. 3B shows three spatial profiles that can be obtained by choosing a length between the input and the output of either 1000 μm, 1235 μm or 1500 μm. As can be seen, the obtained shapes are non-Gaussian, and approach a flat-top shape having side edges more abrupt than side edges of a Gaussian shape. The flat top shape obtained at a length of 1235 μm has a substantially constant value between the side edges, whereas the shape obtained at 1500 μm presents a central dip between the side edges. As can be observed from the simulation shown in FIG. 3A, a longer propagation length would result in a shape that looks like a donut.

In additional to the length of the beam shaping component, the diameters of the inner and outer regions can also be a factor impacting the non-Gaussian shape obtained at the output of the assembly. In the example of FIG. 3A, the diameter of the outer region of the beam shaping component was set to 400 μm, compared with a 125 μm for the optical fiber, which advantageously ensures that the light propagating along the light path is not affected during the propagation length required for its transformation by the outer interface between the outer surface of the beam shaping component and the surrounding medium, typically air, acrylate or a polymer. However in other implementations the beam shaping component may have a smaller diameter and a beam transformation may take place efficiently even if the propagating light is affected by the outer interface.

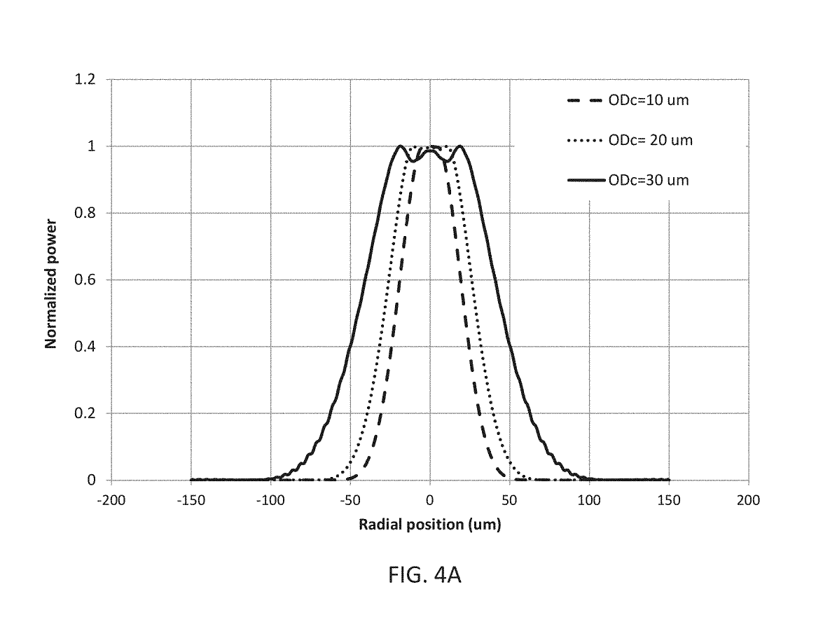

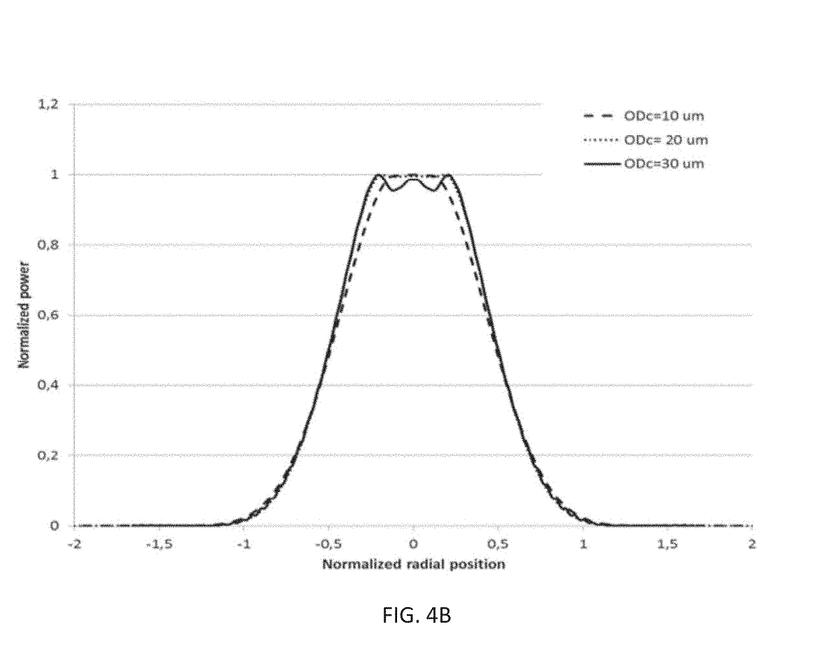

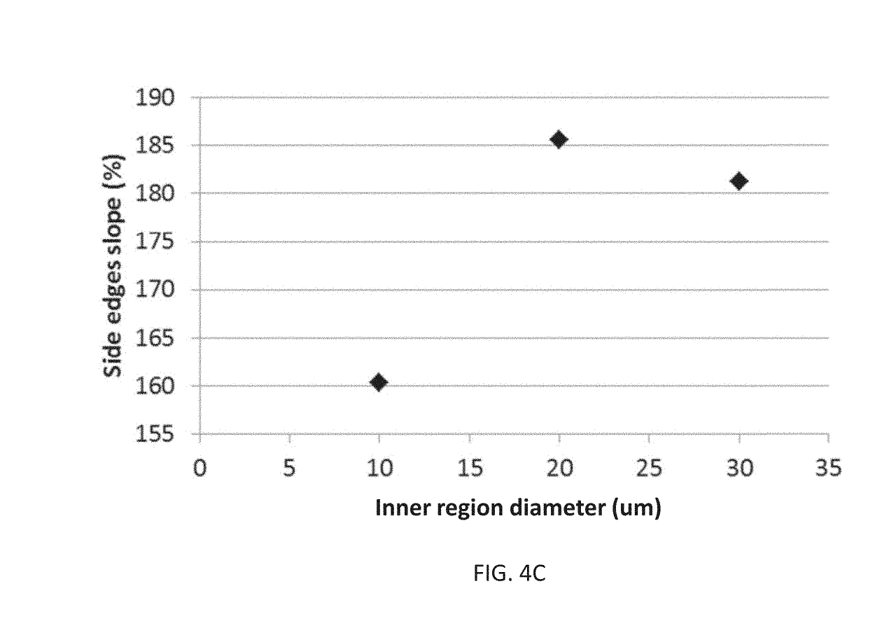

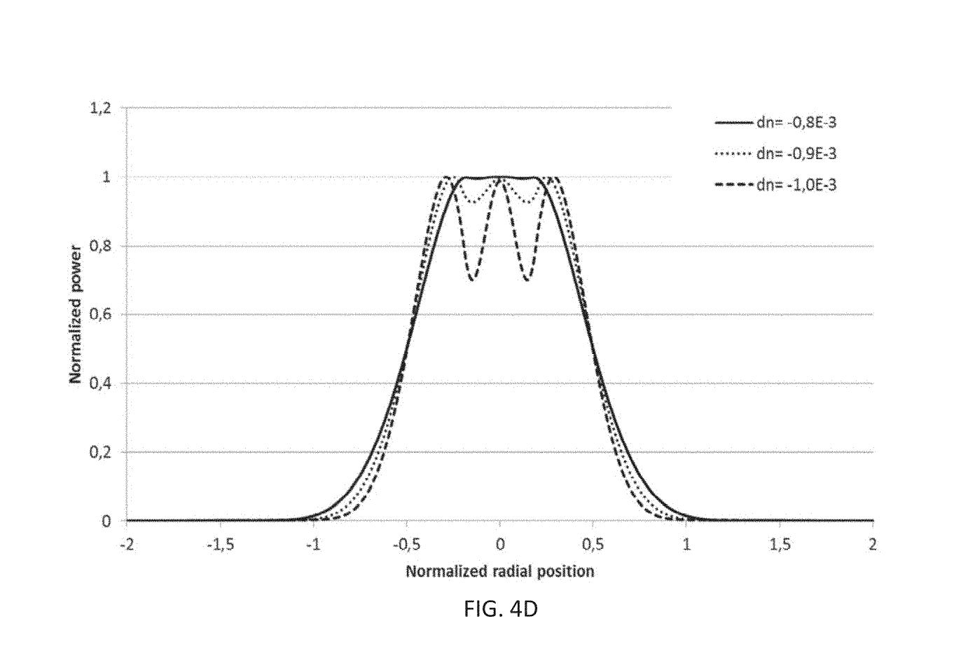

Referring to FIGS. 4A to 4D, the results of simulations for different diameters of the inner region are shown. For same values as above of the refractive indices of the inner and outer regions, beam shaping components having inner regions with three different diameters were simulated, namely, smaller (10 μm), equal to (20 μm) and greater (30 μm) than the diameter of the waveguiding core of the optical fiber. The optical shape obtained for each case is shown in FIG. 4A, normalized in amplitude. It is of interest to note that the length of the beam shaping component which correspond to the best available “flat-top” shape does show a dependency on the diameter of the inner region of the beam shaping component with respect to the diameter of the core of the optical fiber. FIG. 4B shows the same beam shapes normalized in amplitude but also normalized in width with respect to the width at half maximum of the shapes. FIG. 4C shows the calculated normalized slopes of the side edges between 20% and 80% of each curve and dividing by the half width of the beam. It can be seen that the case where the diameter of the inner region is smaller than that of the fiber core results in less abrupt edges of the flat top shape than the other two test cases. Although the equal diameter and greater diameter shapes look similarly flat-top, the slop calculation shows that the case where the diameter of the inner region is the same as the diameter of the waveguiding core of the fiber provides the more abrupt side edges.

Another factor potentially affecting the shape of the transversal profile of the light beam at the output of the beam shaping component is the refractive index difference (dn) between its inner our and outer region(s), sometimes expressed in term of numerical aperture (NA). FIG. 4D shows the spatial profile of the output beam as a function of the dn of the beam shaping component. As can be seen, the steepness of the shape of the spatial profile can be changed with the NA of the beam shaping component, while also affecting the central oscillation.

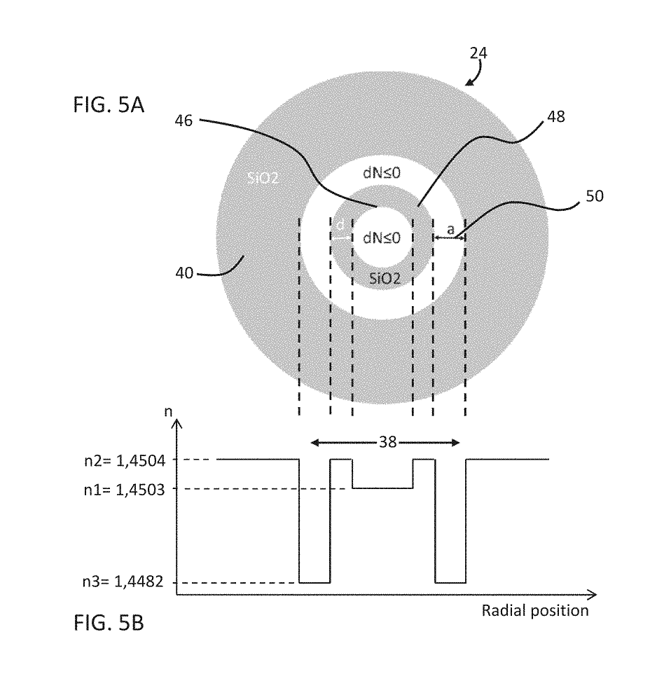

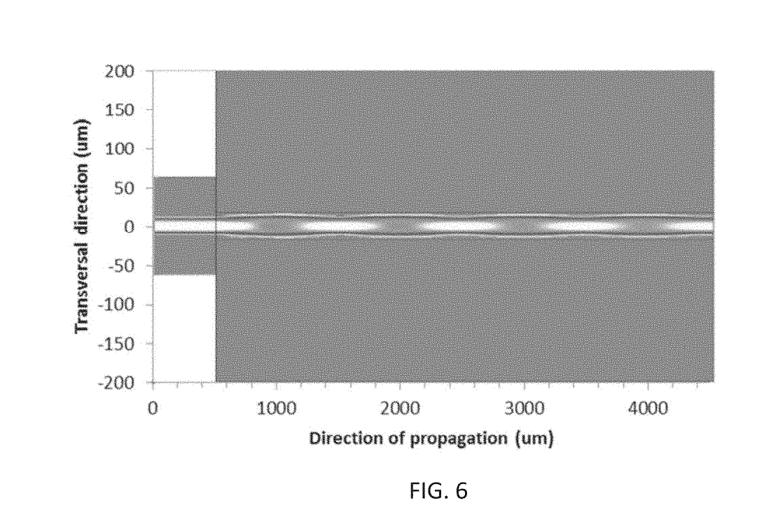

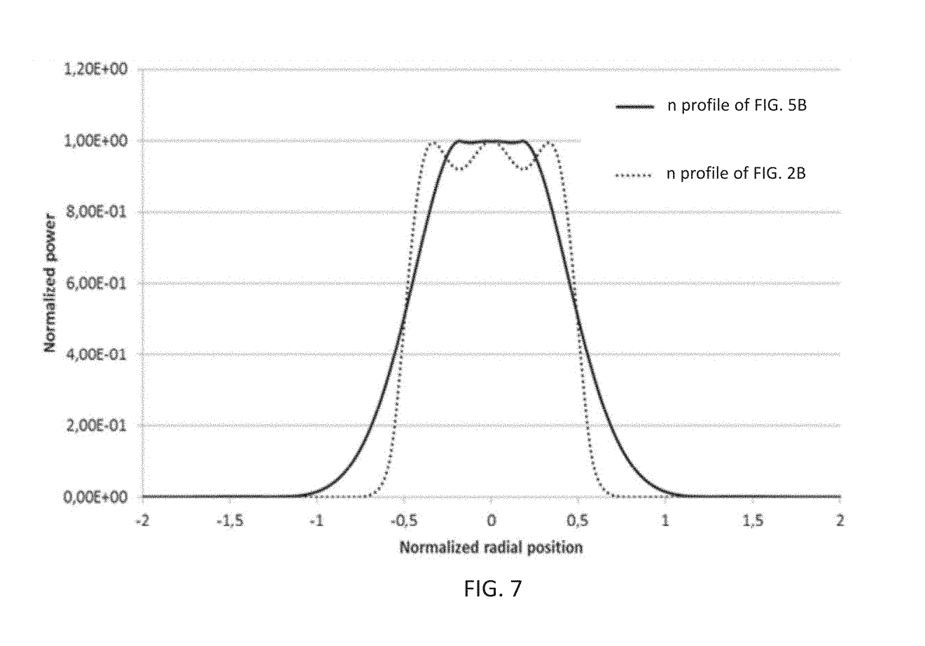

Referring to FIGS. 5A and 5B, there is shown design of a beam shaping component 24 according to another embodiment. As with the embodiment of FIG. 2A, the beam shaping component 24 includes an inner region 38 and an outer region 40. The inner region 38 however here includes, concentrically, a core 46, a first ring 48 and a second ring 50. Preferably, the outer region 40 and the first ring 48 have higher refractive indices than the core 46 and second ring 50, respectively. In one variant, the outer region 40 and first ring 48 of the beam shaping component may be made of a silica glass, whereas the core 46 and second ring 56 of the inner region of the beam shaping component are made of silica glass doped with at least one refractive index-lowering dopant. As mentioned above, the refractive index-lowering dopants may for example be Bore, Fluor or both. In this example, the second ring 56 is more heavily doped than the core 46, so that the refractive index in the second ring 56 is much lower; the refractive index profile in the core 46 makes only a slight dip with respect to the index of pure silica in the first ring 48. In one variant the core 46 and first ring 48 may be made of a same material, and therefore defined a large core structure of constant refractive index value, without affecting significantly the beam transformation.

FIG. 6 shows the result of propagation simulations for the refractive index profile of FIG. 5B. As can be observed, the refractive index difference between the first ring 48 and the second ring 50 leads to guidance of the light beam propagating in the first ring 48. It can still be said, however, that in this embodiment the beam shaping component includes an outer refractive index value (in the outer region 40) greater than an inner refractive index value (in the second ring 50). A flat top is obtained periodically from the superposition of two modes guided by the first ring 48, which are a LP₀₁ and LP₀₂ mode. FIG. 7 shows in dotted an example of the spatial profile obtained for the beam shaping component simulated in FIG. 6, corresponding to the refractive index profile of FIG. 5B. As can be seen, the overall shape obtained provides a flat top with very sharp side edges, even compared with the flat-top shape obtained through the refractive index profile of FIG. 2B, shown for comparison.

In the embodiment shown on FIG. 6, the optical fiber was assumed to be a multimode optical fiber supporting additional modes for transformation by the beam shaping component. The transversal refractive index profile of the beam shaping component provides for the transformation of the spatial profile of each of these additional modes upon their injection at the first end and propagation towards the second end of the beam shaping component. Each additional mode is transformed from an initial shape at the first end to a final shape at the second end different than the first shape. In this embodiment, the additional modes launched in the beam shaping component will excite a few modes that are guided along the propagation length of the beam shaping component. These few modes interfere and form at a given length a modified beam profile compared to the injected beam profile. Advantageously, the sensitivity of this configuration to the length of the beam shaping component is small compared multimode devices such as shown in Zhu (“Coherent beam transformations using multimode waveguides”, Optics Express 7506, Vol. 18, No. 7, 29 Mar. 2010). The number of mode guided by the beam shaping element may be less than twenty and as small as two, such as in the specific case of FIG. 6.

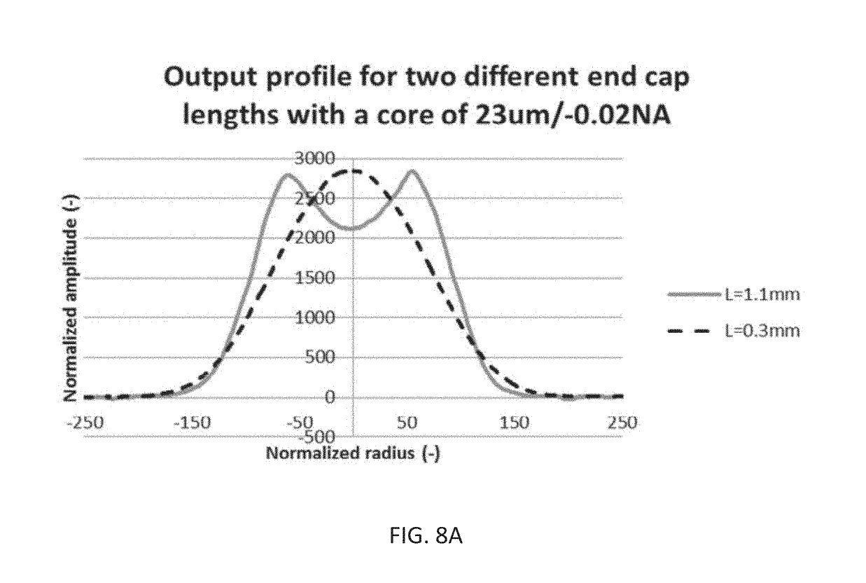

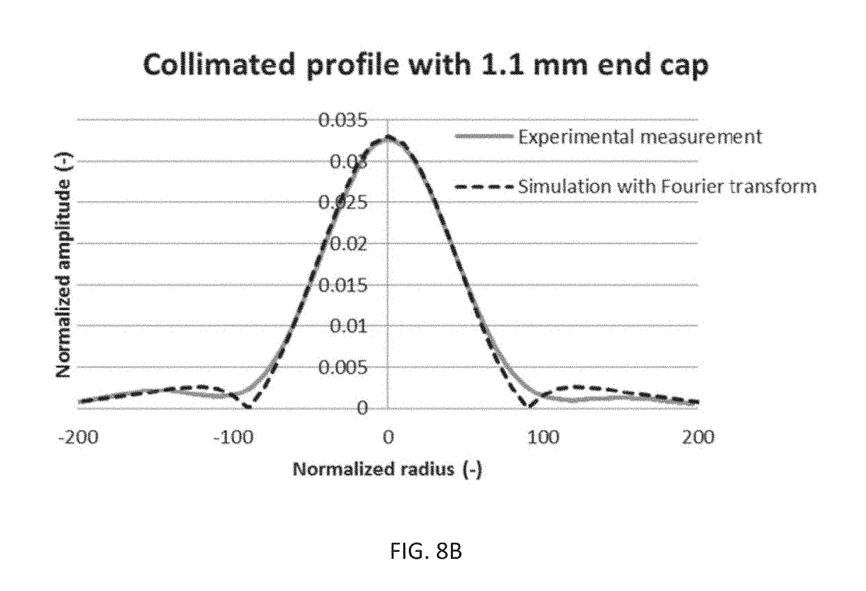

FIG. 8A and 8B shows results obtained from an experimental demonstration using an optical assembly having an optical fiber and a beam shaping component according to one embodiment. The optical fiber had a 20 μm diameter core, a numerical aperture NA of 0.12, a silica cladding having a diameter of 125 μm and supported a Gaussian LP01 mode. The beam shaping component was spliced to the output of the optical fiber as explained above. The beam shaping component had an inner region made of fluorine dope silica and having a diameter of 23 μm and negative NA of −0.023. The beam shaping component further had an outer region made of silica having a diameter of 125 μm. FIG. 8A shows the spatial profile of the light beam at the output of the beam shaping component for two different lengths thereof. As can be observed, a short beam shaping component of 0.3 mm is too small to affect the beam and the profile remains Gaussian. However, using a beam shaping component having a length of 1.1 mm provides the desired beam transformation to a flat-top-like beam profile. A small dip can be seen in the beam spatial profile, but such a feature is not detrimental for several applications.

In the results shown in FIG. 8A, the spatial profile of the beam was measured 1 mm to 35 mm after exiting the optical fiber. The beam profile is measured with a beam profiler. FIG. 8B shows the profile obtained from the beam shaping element of 1.1 mm length, but after the beam is collimated with a diffraction limited aspheric lens of focal length of 11 mm. The fiber tip is placed closed to the focal point of the lens. Using a collimated lens at its focal length is equivalent to performing a Fourier transform of the beam profile since the Fresnel approximation applies to this beam propagation. FIG. 8B shows the calculated Fourier transform of the beam profile of FIG. 8A with the beam shaping component of 1.1 mm. The experimental beam profile is juxtaposed on FIG. 8B. A correlation is obtained between the experiment and the simulation showing the sidelobe in the mode. Then the collimated beam has been refocused using a lens of 250 mm focal length. Behind the focusing lens, the flat top beam profile of FIG. 8A is again obtained over several tens of mm of propagation. FIG. 8A therefore represents both the flat top like beam profile exiting the beam shaping component or re-imaged using a collimating and focusing lens used close to their focal point. In theory, the flat top beam is re-imaged at the focal point of the lens at 250 mm. But in practice, the flat top beam was re-imaged at around 330 mm behind the lens probably due to imperfect collimation. Similar results would be obtained using different types of lens or lens-like system using optical elements with different focal lengths. The flat top beam of FIG. 8A can be transformed in other shapes by using the lens outside of its focal length. For instance, a triangular shape was observed by measuring the beam profile 400 mm after the focusing lens of 250 mm focal length.

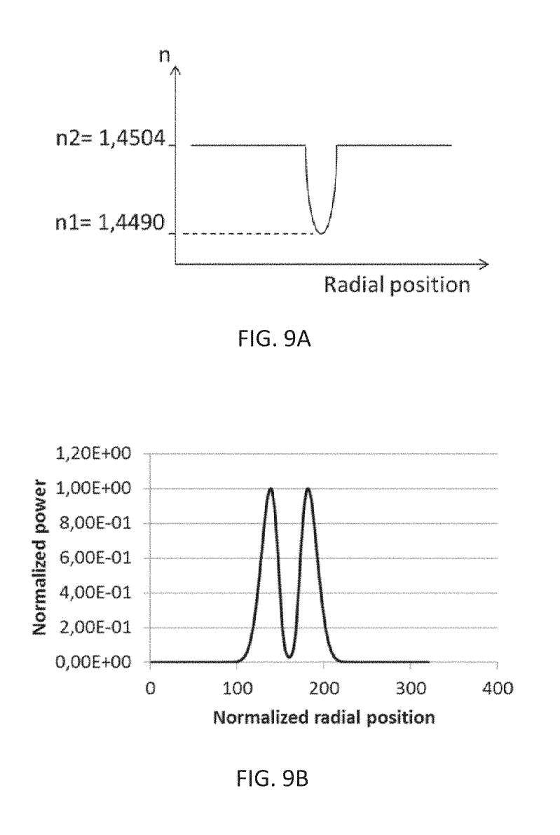

FIG. 9A show the refractive index profile of a beam shaping component according to another embodiment. In this implementation the refractive index profile has a negative gradient-index shape. FIG. 9B shows an example of the beam transformation results of the refractive index profile of FIG. 9A. Using a LP01 Gaussian beam profile from a 20 μm core diameter and 0.10 NA fiber, a beam shaping component of 2.5 mm in length and having the refractive index profile of FIG. 9A was attached to the extremity of the fiber. The refractive index used has a negative peak NA of 0.04 and a half width half maximum of 20 μm. The output beam spatial profile of FIG. 9B shows that the input Gaussian beam is transformed into a donut beam after the propagation of 2.5 mm through the beam shaping component. A similar output spatial profile is obtained for a beam shaping component of 1 mm in length, which seems to indicate the beam output spatial profile is not very sensitive to the fiber length in this implementation. In fact, the simulation shows that much of the beam transformation occurs after a propagation of 500 μm. The diameter of the beam shaping component was set to 400 μm for this simulation.

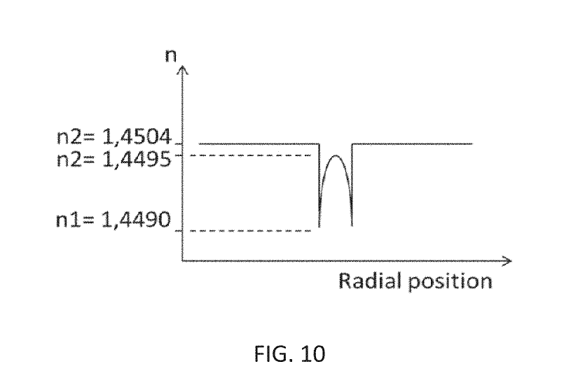

FIG. 10 shows the refractive index profile of a simulated beam shaping component according to another embodiment. This refractive index profile again presents an outer refractive index value greater than an inner refractive index value, with a sharp transition between the two, and the refractive index of the inner region gradually increasing towards the center.

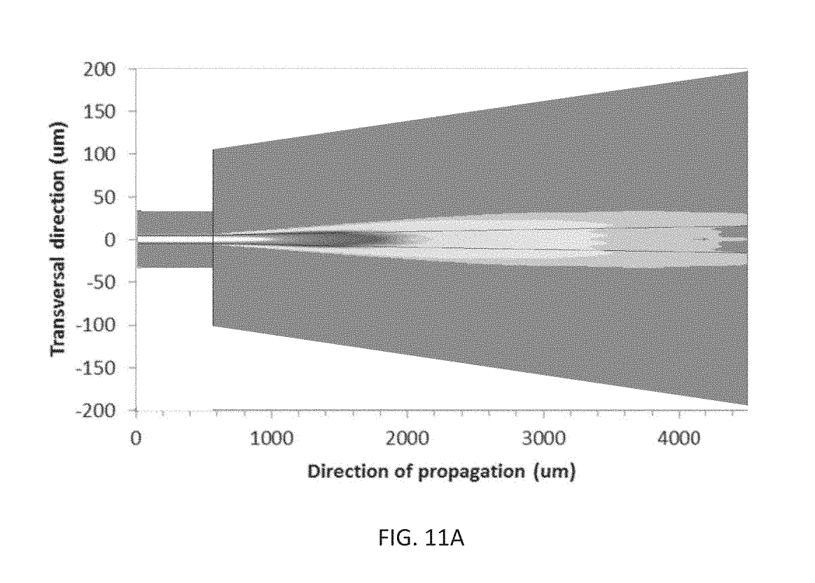

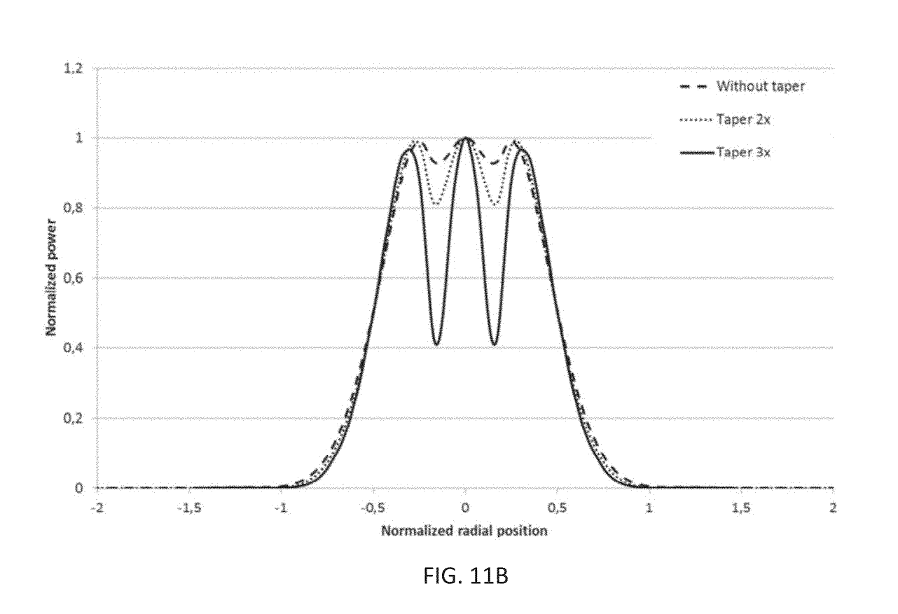

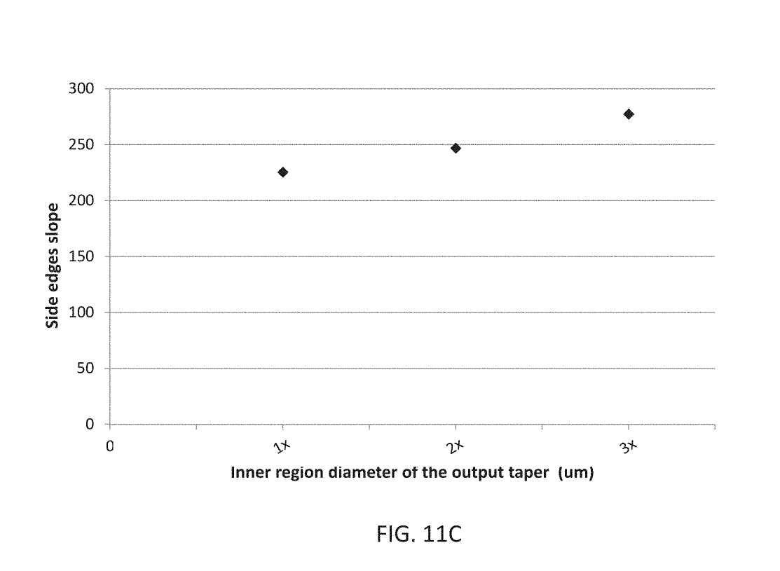

In accordance with other implementations, the beam shaping component may be tapered along the light path, that is, its outer diameter may gradually increase along the propagation direction. Such embodiments may be useful to further optimize the beam transformation. Referring to FIG. 11A, simulation results are illustrated for a configuration similar to the one shown on FIG. 3A, but where the beam shaping component was assumed to have a broadening tapered shape instead of having a constant diameter for the outer region. FIG. 11B shows the spatial profile of the output beam for beam shaping components having a taper ratio of 1, 2 and 3, respectively. As will be readily understood by one skilled in the art, a taper ratio of 3 implies that the outer diameter of the beam shaping component is three times larger at its output end than at its input end. The refractive index profile of the beam shaping component scales proportionally in diameter with the diameter variation of the taper. By calculating the normalised transition slope of the spatial profiles on FIG. 11B, it can be observed that the use of a taper affects the steepness of the flat top beam profile, as illustrated on the graph of FIG. 11C showing the side edge slope as a function of the output inner region core diameter. It is to be noted that although the profile of the taper was varied in a linear manner for the simulation shown herein, different taper shapes, such as for example a raised-cosine or a modified exponential shape, could be used in other variants (Marcuse, “Mode conversion in Optical Fibers with Monotonically Increasing Core Radius”, Journal of Lightwave Technology, Vol. LT-5, No. 1, 1987). The inverse situation, where the output diameter is smaller than the input, may also be done.

It is to be noted that although examples of beam transformation into a flat-top like or donut like beam profile were presented herein by way of example, for other implementations, transformations to other spatial profiles can be achieved using different refractive index profiles in the beam shaping component.

Of course, numerous modifications could be made to the embodiments above without departing from the scope of the invention as defined in the appended claims.

1. An optical fiber assembly, comprising:
an optical fiber supporting a guided mode having a spatial profile defining a first shape;
a beam shaping component having a first end affixed and optically coupled to an extremity of the optical fiber and a second end opposite the first end, the beam shaping component defining a light path between the first and second ends and having a transversal refractive index profile including an outer refractive index value greater than an inner refractive index value, the beam shaping component transforming the spatial profile of a light beam injected at one of the first and second ends and propagating along said light path between said first shape at the first end and a second shape different from the first shape at the second end.

2. The optical fiber assembly according to claim 1, wherein the optical fiber is a single mode optical fiber.

3. The optical fiber assembly according to claim 1, wherein the optical fiber is a multimode optical fiber, the guided mode corresponding to a fundamental mode of said multimode optical fiber.

4. The optical fiber assembly according to claim 1, wherein the input of the beam shaping component is fused with the extremity of the optical fiber.

5. The optical fiber assembly according to claim 1, wherein the beam shaping component has a cylindrical shape of a diameter greater than a diameter of the optical fiber.

6. The optical fiber assembly according to claim 1, wherein a difference between said inner said outer refractive index values is equal to or greater than 1×10⁻⁵.

7. The optical fiber assembly according to claim 1, wherein the first shape is a Gaussian shape and the second shape is a non-Gaussian shape.

8. The optical fiber assembly according to claims 7, wherein the non-Gaussian shape is a flat-top shape having side edges more abrupt than side edges of the Gaussian shape.

9. The optical fiber assembly according to claim 8, wherein said flat-top shape defines a central dip between said side edges.

10. The optical fiber assembly according to claim 8, wherein the beam shaping component has a length between said first and second ends selected to provide said flat-top shape.

11. The optical fiber assembly according to claim 1, wherein the beam shaping component comprises an inner region characterized by said inner refractive index value and an outer region characterized by said outer refractive index value.

12. The optical fiber assembly according to claim 11, wherein:
the optical fiber is a silica-based fiber;
the outer region of the beam shaping component is made of a silica glass; and
the inner region of the beam shaping component is made of silica glass doped with at least one refractive index-lowering dopant.

13. The optical fiber assembly according to claim 12, wherein said at least one refractive index-lowering dopant comprises Bore, Fluor or a combination thereof.

14. The optical fiber assembly according to claim 11, wherein the inner region has a diameter equal to or greater than a diameter of the waveguiding core of the optical fiber.

15. The optical fiber assembly according to claim 1, wherein the beam shaping component comprises:
an inner region comprising, concentrically, a core, a first ring and a second ring; and
an outer region surrounding the inner region;
wherein the outer region and the first ring have higher refractive indices than the core and second ring, respectively.

16. The optical fiber assembly according to claim 15, wherein:
the optical fiber is a silica-based fiber;
the outer region and first ring of the beam shaping component are made of a silica glass; and
the core and second ring of the inner region of the beam shaping component are made of silica glass doped with at least one refractive index-lowering dopant.

17. The optical fiber assembly according to claim 16, wherein said at least one refractive index-lowering dopant comprises Bore, Fluor or a combination thereof.

18. The optical fiber according to claim 16, wherein the second ring is more heavily doped with said at least one refractive index-lowering dopant than the core of the inner region.

19. The optical fiber assembly according to claim 3, wherein the multimode optical fiber supports additional modes for transformation by the beam shaping component, the transversal refractive index profile of the beam shaping component providing for a transformation of a spatial profile of each of said additional modes upon injection thereof at the first end and propagation towards the second end of the beam shaping component from an initial shape at the first end to a final shape at the second end different than the first shape.

20. The optical fiber assembly according to claim 1, wherein the beam shaping component has a tapered shape.
